(19) United States
(12) Patent Application Publication
(10) Pub. No.: US 2008/0223649 A1
(43) Pub. Date: Sep. 18, 2008

(54) VEHICLE FOR TRANSPORTING A WHEELCHAIR

(76) Inventor: Konrad WANDELER, Jona (CH)

Correspondence Address: BROWDY AND NEIMARK, P.L.L.C.;624 NINTH STREET, NW, SUITE 300, WASHINGTON, DC, 20001-5303, US

(21) Appl. No.: 12/046,796

(22) Filed: Mar. 12, 2008

(30) Foreign Application Priority Data
Mar. 12, 2007 (CH) 00398/07

(51) Int. Cl. B60P 1/44

(52) U.S. Cl. 180/333

(57) ABSTRACT

The vehicle has a frame (3) on which a drive mechanism for moving the vehicle is arranged. A platform (4) for the wheelchair (2) is mounted on the frame (3) and can be lowered in order to load the wheelchair (2) onto the vehicle and can be lifted together with the wheelchair (2). The vehicle (1) can be controlled via at least one grip (15, 29) by an attendant or by the person sitting in the wheelchair (2). The grip (15) that can be operated by the attendant is preferably a sensor grip via which the vehicle can be moved without any appreciable force being applied.

The invention relates to a vehicle for transporting a wheelchair, with a frame in which a drive mechanism for moving the vehicle is arranged, and with a platform provided for the wheelchair and mounted on the frame.

Many disabled persons are dependent on a wheelchair. Particularly suitable wheelchairs for such persons are those referred to as manual wheelchairs, which are not motorized and which can be moved by an attendant or by the person sitting in the wheelchair. However, non-motorized wheelchairs have the disadvantage that, on uphill roads and generally in undulating terrain, they cannot be moved by the disabled persons themselves or even by an attendant, as they do not have the strength needed to do this. Consequently, these persons often find themselves unable to get about on undulating terrain.

Various auxiliary drive mechanisms have been disclosed in the prior art that are designed to allow wheelchairs to be pushed or pulled. One such auxiliary drive mechanism is disclosed in EP 0 419 085 A, for example. It is also possible to couple a wheelchair to a bicycle, as is proposed in EP 0 863 067 A. Motorized wheelchairs are also known. However, the stated auxiliary drive mechanisms are heavy, unwieldy and relatively difficult to assemble. Motorized wheelchairs are relatively expensive and, above all, are not very suitable for transport by train.

EP 1 616 545 A has disclosed a vehicle onto which a wheelchair can be loaded. The vehicle is provided for moving a wheelchair on stairs. This is a specialized vehicle and is not suitable for moving a wheelchair along a road.

The object of the invention is to create a vehicle of the stated type that avoids the stated disadvantages. The vehicle is also intended to allow elderly and infirm persons to get about even on hilly terrain.

In a vehicle of the type in question, the object is achieved by the fact that the platform can be lowered for loading the wheelchair onto the vehicle, and the vehicle can be controlled via at least one grip by an attendant or by the person sitting in the wheelchair. The attendant controls the vehicle preferably while walking. It is also conceivable, however, for the vehicle to have a footplate on which the attendant can stand and thus travels with the vehicle. The lowerable platform permits very easy loading of the wheelchair onto the vehicle. In the process, the disabled person is able to remain seated in the wheelchair. The at least one grip permits very simple control of the vehicle. The grip can be arranged such that the vehicle can be controlled by the disabled person himself or herself. Alternatively, a grip is possible that allows the vehicle to be controlled by the attendant. It is also possible to have two grips, one for the disabled person and the other for the attendant. In this case, the control is programmed such that one grip has priority.

It is important that the vehicle allows a conventional wheelchair, and in particular a manual wheelchair, to be driven by a motor. For example, the vehicle allows an attendant to move a wheelchair across undulating ground to a train station. The wheelchair can then be used for onward transport by train, the vehicle being left at the station. After the platform has been lowered, it can also be unloaded very easily and without applying force.

According to a development of the invention, the grip is a joystick for a self-propelled wheelchair, or it is a grip arranged on a rear face of the frame.

Moving the vehicle is made particularly easy for an attendant if the grip is what is called a sensor grip. Such a sensor grip permits particularly simple and intuitive operation with minimal force. The speed of the vehicle is regulated automatically by the speed at which the attendant is walking. A capacitive or other type of hand recognition can be integrated into the grip along with buttons for switching the motor on and off, and displays for showing the state of charge of the battery, for example. The grip can also be designed in such a way that, when it is let go, a brake is automatically activated.

The operation of the vehicle is made particularly easy for an attendant if two grips arranged at a distance from each other are secured on the rear face of the vehicle. This permits in particular a high degree of maneuverability.

According to a development of the invention, the vehicle has two wheels, which each have a drive mechanism. The drive mechanisms are preferably wheel-hub drives.

According to a development of the invention, the two driven wheels are at a distance from each other that is smaller than the usual distance between the two rear wheels of the wheelchair. The drive wheels of the vehicle are therefore always situated between the two rear wheels of the wheelchair. In this way, it is possible for the drive wheels and the rear wheels of the wheelchair in the direction of travel to overlap. This allows the vehicle to have a particularly small structure. In addition, wheelchairs with very different distances between the rear wheels can be used.

According to a development of the invention, the platform can be adjusted in height and can be set down on the ground on which the vehicle is travelling. When the platform is set down on the ground, the wheelchair can be driven smoothly onto the platform. The vehicle is set down in a stable manner and cannot tip over.

According to a development of the invention, the platform has, at a distance from a front edge, two recesses or depressions which are spaced apart from each other and into which a respective rear wheel of a wheelchair can be lowered and coupled. This permits particularly simple and secure coupling or fixing of the wheelchair on the vehicle. As the wheelchair is being driven onto the platform, the two rear wheels move automatically into the recess or depression, and in this way the wheelchair is fixed by its own weight. The wheelchair then simply needs to have its own brake applied too. It is then fixed securely on the vehicle. Further securing means are not required. In the fixed state, the two rear wheels of the wheelchair each rest on a front edge of the recess and on an abutment plate.

The energy source provided for the vehicle is in particular and preferably an electric battery or accumulator. The platform is preferably moved by an electric lifting mechanism, for example by means of a spindle. The platform is preferably lowered and raised via four levers, which are articulated at a distance from one another on a bottom part of the frame.

Further advantageous features will become clear from the dependent patent claims, from the following description and from the drawing.

An illustrative embodiment of the invention is explained in more detail below with reference to the drawing, in which:

FIG. 1 shows a perspective view of a vehicle according to the invention,

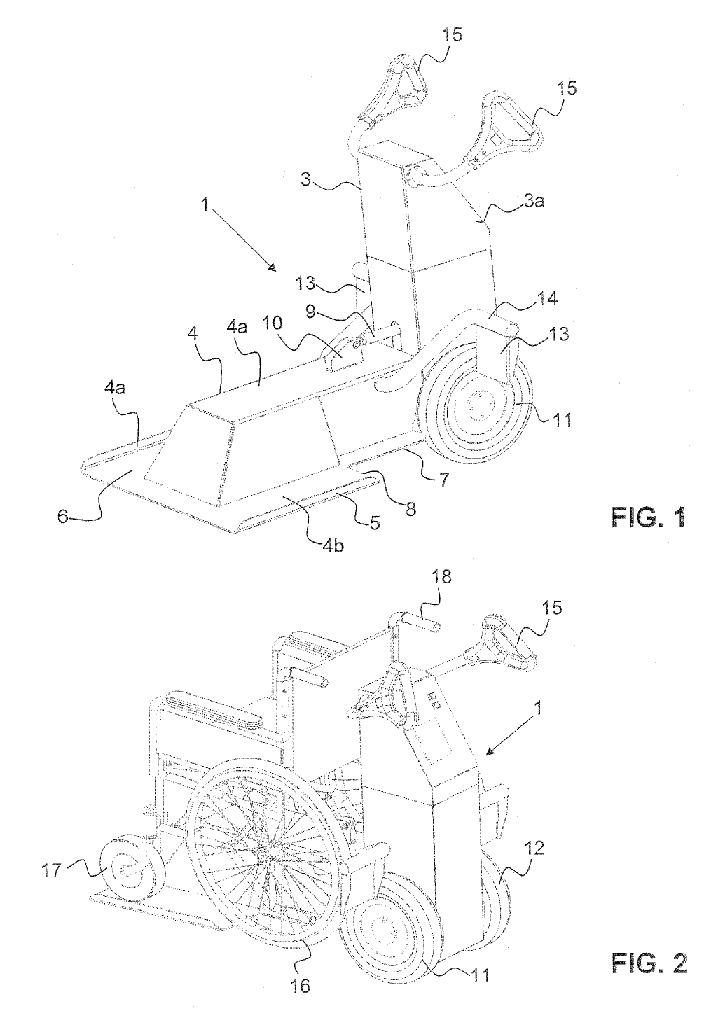

FIG. 2 shows another perspective view of the vehicle, with a wheelchair having been loaded onto it,

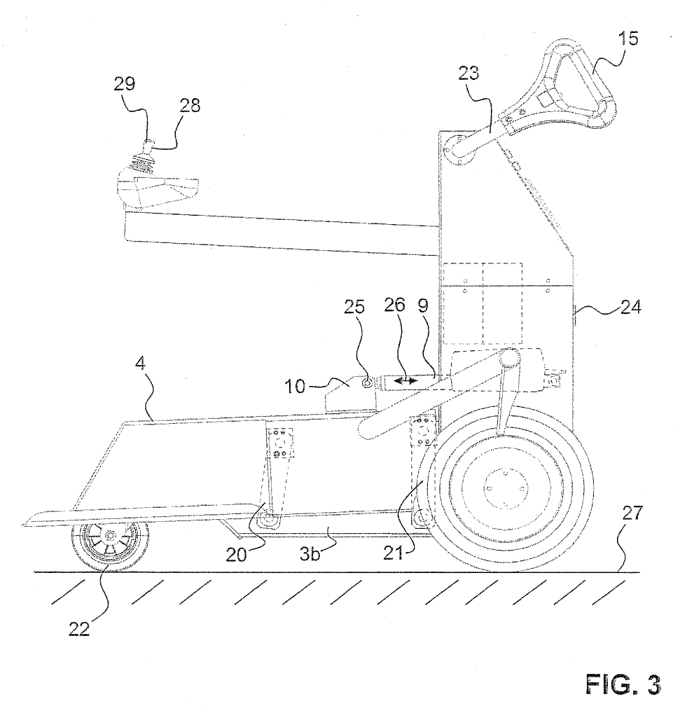

FIG. 3 shows a side view of the vehicle according to the invention,

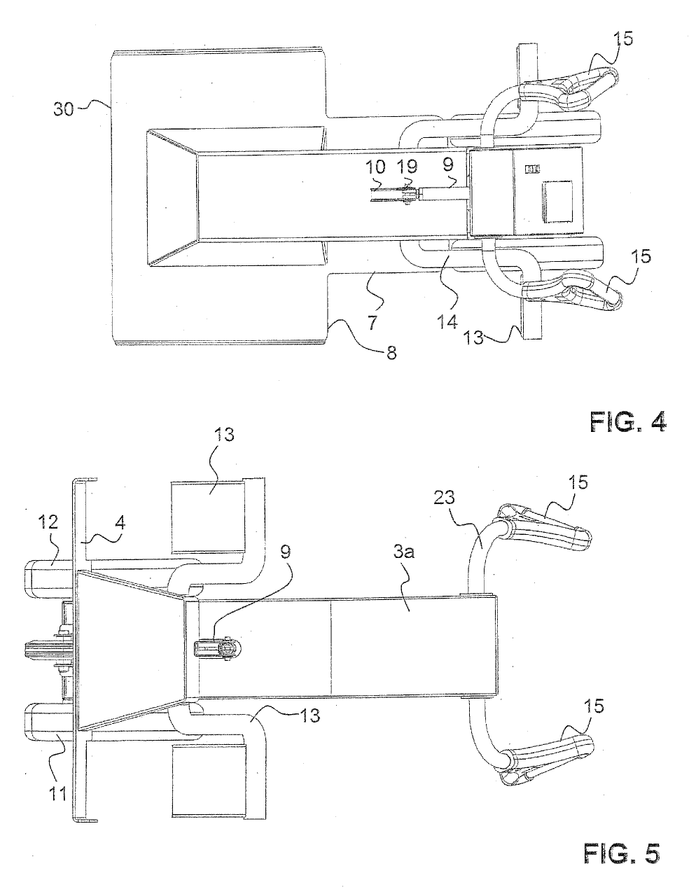

FIG. 4 shows another view of the vehicle according to the invention, and

FIG. 5 shows another view of the vehicle according to the invention.

FIG. 1 shows a vehicle 1 according to the invention, having a frame 3 on which a left-hand wheel 11 and a right-hand wheel 12 are mounted. Seen in the direction of travel, these wheels 11 and 12 are located in the rear area. The wheels 11 and 12 each comprise a wheel-hub drive, which is known per se and is not shown here. The two wheel-hub drives each comprise a control means. These two wheel-hub drives are preferably designed in such a way that the control means of one drive reads the parameters of the other drive. As an energy source for the two wheel-hub drives, a battery is accommodated in a casing 3a of the frame 3. An internal charging device with electronic monitoring of the charging current is also located in the casing 3a.

A wheel 22, which can be seen in FIG. 3, is also arranged more or less centrally on a bottom part 3b of the frame, at a distance from the wheels 11 and 12. Instead of this individual wheel 22, two wheels arranged at a distance from each other can also be secured on the bottom part 3b of the frame. The wheel 22 or the two said wheels are mounted movably on the bottom part 3b.

The bottom part 3b of the frame is covered by a platform 4, which is mounted on the bottom part 3b of the frame so as to be able to be lowered via levers 20 and 21. The front two levers 20 and 21 can be seen in FIG. 2. At a distance from these, two similar levers (not shown here) lie opposite each other. The platform 4 is thus mounted on four levers. At lower ends, these levers are each secured on the bottom part 3b of the frame via a pivot hinge 25.

The platform 4 has an approximately U-shaped surface 6 and, centrally, an upwardly extending hood 4a, on the top of which a bearing part 10 is secured. A lifting mechanism 9 engages on this bearing part 10. This is preferably, but not necessarily, an electrical drive mechanism. The movement is, for example, effected in a manner known per se via a spindle (not shown here). A pivot hinge 19 (FIG. 3) connects the lifting mechanism 9 to the bearing part 10. The double arrow 26 indicated in FIG. 3 shows the movements of the lifting mechanism. If the platform 4 is moved to the left in FIG. 3, and therefore forwards, the levers 20 and 21 are correspondingly pivoted in the counter-clockwise direction. The platform 4 is thereby lowered until it strikes a ground surface 27. In the other direction of the double arrow 26, the platform 4 is moved away from the ground surface 27 to the raised position shown in FIG. 3. In this position, the two levers 20 are inclined rearwards, such that the platform 4, when loaded, is already held in this position by its own weight. It is further fixed by the lifting mechanism 9 in the corresponding position.

When the platform 4 is in the lowered position, a wheelchair 2 shown in FIG. 2 can be smoothly moved onto it. The wheelchair is what is referred to as a manual wheelchair and can be pushed via two grips 18. Two rear wheels 16 and two smaller front wheels 17 are designed in the usual way. The platform 4 has for this purpose an approximately U-shaped, horizontally extending edge 4b. At two parallel opposite sides, this edge 4b is limited by upwardly directed rims 5. FIG. 2 shows the wheelchair 2 in a position in which it is transported on the platform 4. When being placed on the platform 4, the wheelchair 2 rolls rearwards counter to the direction of travel of the vehicle 1, until the rear wheels 16 of the wheelchair 2 each strike against an abutment plate 13. The two wheels 16 each engage with a lower area into a recess 7. At the front, they each rest against an edge 8 that extends outwards transverse to the direction of travel. The two edges 8 and the abutment plates 13 are comparatively wide, such that wheelchairs 2 with very different distances between the wheels 16 can be arranged on the platform 4. Since the two wheels 16 rest against the edges 8 and the abutment plates 13, the wheelchair 2 is already fixed very securely on the platform 4. If, in addition, the brakes of the wheelchair 2 are applied, this results in very secure fixing. Finally, the platform 4 in the raised position is inclined rearwards in relation to the bottom part 3b of the frame.

The distance between the two wheels 11 and 12 is smaller than the distance between the two wheels 16 of the wheelchair 2. This permits an arrangement of the wheelchair 2 in which the wheels 11 and 12 and the wheels 16 overlap slightly in the view according to FIG. 3. This permits a particularly short structure of the vehicle 1. The two abutment plates 13 are accordingly arranged in such a way that they are located approximately over the axle of the two wheels 11 and 12, as can be seen particularly in FIG. 3. The two abutment plates 13 are secured via supports 14 that connect the plates 13 to the platform 4. When the platform 4 is moved, the two abutment plates 13 are therefore also moved. As a result, the wheelchair 2 cannot roll back in the raised position or in the lowered position.

The vehicle 1 can be moved and controlled by an attendant, who is not shown here. For this purpose, two grips 15 are arranged on the frame 3. These grips 15 are secured on the frame 3 via curved tubes 23 in such a way that, as can be seen, they protrude rearwards and can be gripped by hand by the attendant. The grips 15 are what are referred to as sensor grips. Such grips, which are known per se, are equipped with strain gauges or piezo crystals and allow the vehicle to be controlled very easily and safely. At least one of these grips 15 preferably comprises a hand recognition, for example a capacitive hand recognition. Using these grips 15, the vehicle 1 can be moved without applying any appreciable force. Very slight forces applied to the grips 15 are converted into corresponding commands. The vehicle 1 can thus be moved very easily and by intuitive operation. The speed of the vehicle 1 adapts automatically to the walking speed of the person operating it. Corresponding control mechanisms are known per se. In particular, automatic braking is provided as soon as the grips 15 are let go. The two motors of the wheels 11 and 12 immediately come to a stop as soon as the two grips 15 are let go. This ensures that the vehicle 1 is braked as soon as it is no longer being held via the grips 15.

Instead of or in addition to the two grips 15, a joystick 28 (FIG. 3) can be provided. This is arranged such that it can be operated by the person sitting in the wheelchair 2. The control is effected by the corresponding movement of a grip 29. This is likewise possible with application of a very slight force. If the vehicle 1 is provided with the grips 15 and also with the joystick 28, the control is programmed in such a way that one of the grips has priority. For example, the two grips 15 can be given priority. If the grips 15 and also the joystick 28 are actuated, this means the drive is provided by the grips 15. It is also possible to use a selector switch (not shown here) to choose which control is intended to have priority.

The vehicle 1 has a plug-in connection (not shown here) for a computer, which according to FIG. 3 is covered by a removable cover 24. The maximum speed can be set, for example, by appropriate programming. However, other parameters can also be programmed here, thus permitting substantial adaptation to the user. It is also possible to provide displays showing the state of charge of the battery. A switch is also provided for turning the lifting mechanism 9 on and off. The end positions, for example, can be set via switches (not shown here). The vehicle 1 can be driven only when the platform 4 with the wheelchair 2 has reached the end position. In this position, the platform 4 is inclined slightly towards the front, for example by 1 to 4 and preferably approximately 2 angle degrees. On being lifted, the platform 4 is initially inclined rearwards and only thereafter is inclined forwards into the end position. This ensures that the wheelchair can be loaded safely and in a way that is convenient for the person in the wheelchair and also for the attendant.

### LIST OF REFERENCE NUMBERS

1 vehicle
2 wheelchair
3 frame
3a casing
3b bottom part of frame
4 platform
4a hood
4b edge
5 rim
6 surface
7 recess
8 edge
9 lifting mechanism
10 bearing part
11 left-hand wheel
12 right-hand wheel
13 abutment plate
14 support
15 grip
16 rear wheel of wheelchair
17 front wheel of wheelchair
18 wheelchair grip
19 hinge
20 front lever
21 rear lever
22 front wheel
23 tube
24 cover
25 pivot hinge
26 double arrow
27 ground
28 joystick
29 grips
30 front edge

1. Vehicle for transporting a wheelchair, with a frame on which a drive mechanism for moving the vehicle is arranged, and with a platform provided for the wheelchair and mounted on the frame, wherein the platform can be lowered for loading the wheelchair onto the vehicle and can be lifted together with the wheelchair, and the vehicle can be controlled via at least one grip by an attendant or by the person sitting in the wheelchair.

2. Vehicle according t o claim 1, wherein the grip is a joystick for the self-propelled wheelchair or it is at least one grip which is arranged on a rear face of the frame and via which the vehicle can be controlled by an attendant.

3. Vehicle according to Claim 1, wherein at least one grip is a sensor grip.

4. Vehicle according to claim 3, wherein two grips are arranged on the rear face of the frame, and in that an attendant can move the vehicle by hand via these two grips without applying any appreciable force.

5. Vehicle according to claim 1, wherein it has two wheels, which each have a drive mechanism and in particular an electrical wheel-hub drive.

6. Vehicle according to claim 5, wherein the first wheel-hub drive has a control means, and the other wheel-hub drive is controlled by this control means.

7. Vehicle according to claim 1, wherein the two driven wheels are at a distance from each other that is smaller than the usual distance between the rear wheels of the loaded wheelchair.

8. Vehicle according to claim 1, wherein the platform can be adjusted in height by a drive mechanism, in particular by a lifting mechanism, and can be set down on the ground on which the vehicle is travelling.

9. Vehicle according to claim 1, wherein at least one drive mechanism is a wheel-hub drive.

10. Vehicle according to claim 1, wherein the platform has, at a distance from a front edge, two recesses which are spaced apart from each other and into which a respective rear wheel of a wheelchair can be lowered and coupled.

11. Vehicle according to claim 10, wherein the two recesses each have a front edge which extends substantially at right angles to the direction of travel and on which one of the two wheels rests.

12. Vehicle according to claim 1, wherein it has a grip for control by the person in the wheelchair and at least one grip for control by an attendant, and in that a priority is set for one of the two possible controls or can be set by means of a selector switch.

13. Vehicle according to claim 1, wherein the platform can be lifted by an electrical lifting mechanism to a substantially horizontal position.

14. Vehicle according to claim 13, wherein the platform, in a raised end position, is inclined forwards by a few angle degrees, preferably by approximately 1 to 4 angle degrees.
